(19) United States
(12) Patent Application Publication
(10) Pub. No.: US 2008/0027996 A1
(43) Pub. Date: Jan. 31, 2008

(54) METHOD AND SYSTEM FOR SYNCHRONIZING DATA USING A PRESENCE SERVICE

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/461,448

(22) Filed: Jul. 31, 2006

(51) Int. Cl. G06F 17/30

(52) U.S. Cl. 707/200

(57) ABSTRACT

A method of synchronizing data using a presence service includes receiving, via a presence service, a first message that includes presence information from a first data store client of a group of data store clients. The first message is compatible with a transmission format that includes a status element for carrying a first status value that indicates that content in the first data store client has changed since a prior synchronization operation, if any, has occurred with a second data store client of the group. In response to receiving the first message, a second message is sent that enables a synchronization operation to occur for synchronizing content of the first data store client and the second data store client based on the change in the content of the first data store client.

### BACKGROUND

Many, if not all, electronic devices allow users to collect and store information including contact information, scheduling information, files, and other data. Such information is typically stored in a data store, examples of which can include databases, file systems, directory services, FTP mirrors and the like. In many situations, the information stored in one data store must be substantially the same as that stored in another data store. For example, electronic devices such as laptop computers or PDAs issued by an enterprise to its employees should contain up-to-date and substantially the same enterprise information so that all employees can access substantially the same data. In another example, different personal electronic devices, e.g., a laptop computer, a smart phone, and a PDA, used by a single user should also contain up-to-date and substantially the same contact and calendaring information so that the user can access the information using any device.

When the data in one of several data stores is modified, e.g., when a new contact name is added to an address book, the data in the other data stores is “out-of-sync” with the data in the one data store. A data synchronization operation executed between the one data store and the other data stores modifies the data in the other data stores and brings the other data stores back “in-sync” with the one data store. When the data across several electronic devices is synchronized, the user can be assured that the most current data is available regardless of the electronic device in use.

Typically, synchronization operation programs can automate the synchronization process. Generally, however, synchronization programs are platform dependent, that is, they are vendor, application, or operating system specific. For example, ACTIVESYNC® is a synchronization program developed by MICROSOFT® Corporation that automatically synchronizes WINDOWS®-based personal computers and WINDOWS-based mobile handheld devices. The program is designed to synchronize personal information manager (PIM) data with MICROSOFT OUTLOOK®. Because many synchronization operation programs are platform dependent, it is difficult to synchronize data across devices that run different platforms. For example, ACTIVESYNC cannot be used for synchronizing some non-MICROSOFT PIMs. In those instances, another synchronization program can be used if it is available. If such a program has not been developed, however, data synchronization must be performed manually. Manual updates can be error ridden and extremely time consuming.

### SUMMARY

According to one embodiment, a method of synchronizing data using a presence service includes receiving, via a presence service, a first message that includes presence information from a first data store client of a group of data store clients. The first message is compatible with a transmission format that includes a status element for carrying a first status value that indicates that content in the first data store client has changed since a prior synchronization operation, if any, has occurred with a second data store client of the group. In response to receiving the first message, a second message is sent that enables a synchronization operation to occur for synchronizing content of the first data store client and the second data store client based on the change in the content of the first data store client.

According to another embodiment, a method for synchronizing data content in a first data store client with data content in a second data store client using a presence service includes determining, by the first data store client, a change in data content of the first data store client and setting a value of a status element to a first status value indicating that data content in the first data store client has changed since a prior synchronization operation, if any, has occurred with the second data store client. The first data store client then sends a message that includes presence information and the first value to a presence service via a publish command capable of sending the presence information including the first value. The publish command is compatible with a transmission format that provides a status element for carrying the first value.

According to another embodiment, a system for synchronizing data in a group of data store clients using a presence service includes a data store for storing presence information including status information, and at least one presence server. The presence server includes a presence service and a network protocol stack component and a presence protocol layer for communicating with at least one presence service client. The presence service includes a publication handler component, operatively coupled to the data store, that is configured to receive a first message, which includes presence information from a first data store client of a group of data store clients. The first message is compatible with a transmission format that includes a status element for carrying a first status value indicating that content in the first data store client has changed since a prior synchronization operation, if any, has occurred with a second data store client of the group. The presence service also includes a notify component operatively coupled to the data store, that is configured to send a second message that enables a synchronization operation to occur for synchronizing content of the first data store client and the second data store client based on the change in the content of the first data store client in response to receiving the status element comprising the first value from the first data store client. The presence service also includes a command router component, operatively coupled to the publication handler and notify components and to the network protocol stack component. The command router component is configured to route the first message and second message between publication handler and notify components.

According to another embodiment, a data server includes a data store, a data manager component for managing data content in the data store and for determining a change in content in the data store, and a data synchronization component, operatively coupled to the data manager component. The data synchronization component is configured to set a value of a status element to a first value indicating that content in the data store has changed since a prior synchronization operation, if any, has occurred with another data store. The data server also includes a network protocol stack component and a presence protocol layer configured to communicate with a presence service and a presentity component, operatively coupled to the data synchronization component and to the network protocol stack component. The presentity component is configured to send a first message including presence information and the first value to the presence service via a publish command capable of sending the presence information including the first value compatible with a transmission format providing a status element for carrying the first value.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a block diagram illustrating an exemplary system for synchronizing data using a presence service according to one embodiment;

FIG. 2 is a block diagram of an exemplary data store client according to one embodiment;

FIG. 3 is a block diagram of an exemplary presence server 300 according to one embodiment;

FIGS. 3A and 3B are exemplary tuples that support data synchronization according to embodiments;

FIG. 4A and FIG. 4B are flow diagrams illustrating an exemplary process for synchronizing data according to two embodiments;

FIG. 5A is a block diagram illustrating a system for synchronizing data using a presence service according to another embodiment;

FIG. 5B is a block diagram of an exemplary presence service 310 according to another embodiment; and

FIG. 6 is a flow diagram illustrating an exemplary process for synchronizing data using a synchronization monitor according to one embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to an exemplary embodiment, data synchronization is implemented using a presence service. Conventional presence services are a type of publish/subscribe service, both of which are well known to those skilled in the art. Publish/subscribe (“pub/sub”) services allow an entity, referred to as a subscriber or subscriber client, to subscribe to information provided by another entity, referred to as a publisher. Publishers publish to a distinct ID, typically a uniform resource identifier (URI) or uniform resource locator (URL), and subscribers subscribe by providing the ID. The publisher posts, i.e., publishes, the information to the pub/sub service identifying a data structure, i.e., tuple, to be created or updated, the service then transmits the published tuple information to all interested parties, i.e., subscribers, via notification messages. The published information can be read simultaneously by any number of subscribers. So long as the subscriber remains subscribed to the information, the subscriber will continue to receive notification messages corresponding to the publisher's postings.

Notably, as is used herein, the term “publish/subscribe” refers to the class of services and associated protocols where a subscriber receives only the most recently published information in a notification message resulting from a subscription. That is, the pub/sub service transmits to the subscriber only the most current state of the published information, and does not queue, or store, previously published data for retrieval when the subscriber is offline or otherwise unsubscribed, such as with email and traditional message queues. Thus, unlike typical message queuing services, when a subscriber logs on or subscribes to the pub/sub service, the subscriber receives only the current state of the information, as well as subsequent updates to the information while the subscriber is subscribed. The subscriber does not receive previous updates that may have occurred while the subscriber was offline or unsubscribed. In addition, the pub/sub services as described herein are not topic-based subscription services where typically any number of publishers may contribute to a single subscription. In topic-based subscription services, whether a published entity is sent to a subscriber is based on its topic or categorization. Such topic-based subscription services are also sometimes referred to as pub/sub services.

As a pub/sub service, the presence service allows a client to subscribe to presence information published by the client's friends, and allows the client to publish its presence information to the client's friends who are presently subscribed. Presence information includes status information relating to the publisher. For example, presence information can include the client's status, e.g., “on-line,” “out-to-lunch,” and the client's preferred communication mode. A presence service can convey a user's presence on a network to other subscribing clients based on the user's connectivity to the network via a client device, such as a personal computer or mobile telephone.

The presence information describing a user's presence on the network can be used by applications and/or other services to provide what are referred to here as “presence applications”. A popular presence application is instant messaging (IM). IM applications include Yahoo's YAHOO MESSENGER®, Microsoft's MSN MESSENGER®and America Online's AOL INSTANT MESSENGER or AIM®. IM applications use presence services to allow users to check the connectivity status of other users, i.e., who is connected to the network, and to determine whether the other users are available to participate in a communication session.

As a pub/sub service, the presence service typically transmits presence information in a transmission data formats known as presence tuples. Typically, a presence tuple includes an element for a client's status, and can include one or more “contact” elements for contact information associated with the client, as well as other elements for other information. The term tuple may be used to refer to the transmission format and the storage format of the data exchanged using a pub-sub or presence protocol. Whether tuple refers to a transmission data format or a data storage format will be clear from the context. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence”, each of which are published and owned by the Internet Society and incorporated here in their entirety by reference.

As described above, presence information is used primarily to allow humans to inform other humans regarding their status as it pertains to their availability to engage in a communication session. Currently, presence status is, for the most part, passive. There is no expectation, at least at the machine level, that a given status will evoke a predictable action or reaction of a presence client.

According to an exemplary embodiment, however, presence status has an active effect. In particular, a given status triggers an event, namely a synchronization operation. In one embodiment, an electronic device that includes a data store is a presence client, referred to herein as a “data store client,” that is configured to publish its presence information via the presence service. The presence information includes status information that can indicate content in the data store that has changed since a prior synchronization operation, if any, has occurred with another data store client. When the status information indicating such a change in content is received by a presence client subscribed to the status information, a synchronization operation can be initiated to synchronize the content in the other data store client(s) with that in the publishing data store client in substantially real time.

In an exemplary embodiment, the presence information can also include change information that comprises the changed content of the publishing data store client. When the change information is received by a subscribing client, via the presence service, the change information can be used during the synchronization operation.

Using a presence service to facilitate data synchronization can provide many benefits. First, a presence communication protocol provides a common, i.e., platform independent, command set that allows a data store client to publish its presence information and to subscribe to other clients' presence information without regard to platform-specific factors. Thus, different data store systems can exchange vital synchronization information with each other using a standardized presence communication protocol. Second, because presence services are pub/sub services, a plurality of subscribed clients can receive the published presence information substantially at the same time and substantially in real time. In addition, presence services are enabled to traverse firewalls, and therefore synchronization messages can be received and transmitted across typically isolated domains.

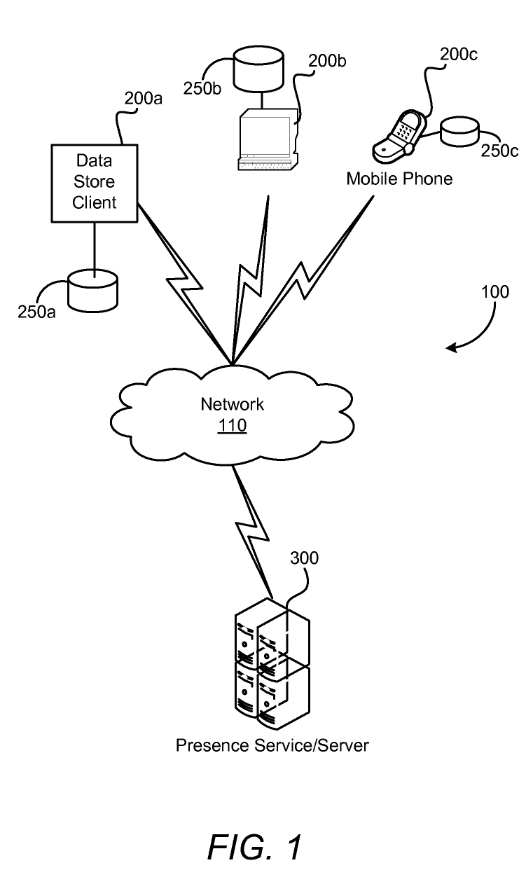

FIG. 1 illustrates a block diagram of an exemplary system for synchronizing data using a presence service according to one embodiment. The system 100 includes a group of at least two data store clients 200a-200c, and at least one presence server 300. Each data store client 200a-200c includes at least one data store 250a-250c for storing data content. Exemplary data stores can include relational databases, File Systems, Directory Services, Calendars, FTP mirrors, and processor memory spaces. The at least two data store clients 200a-200c form a group in which the content of each data store 250a-250c is substantially the same, i.e., synchronized. The data store client, e.g., 200b, can be hosted by any network-enabled electronic device, examples of which include a smartphone, a personal digital assistant (PDA), a personal computer (PC), and the like. In an exemplary embodiment, the presence server 300 and the group of data store clients 200a-200c are coupled to a network 110 so that the data store clients 200a-200c can communicate with each other as well as with the presence server 300 over the network 110.

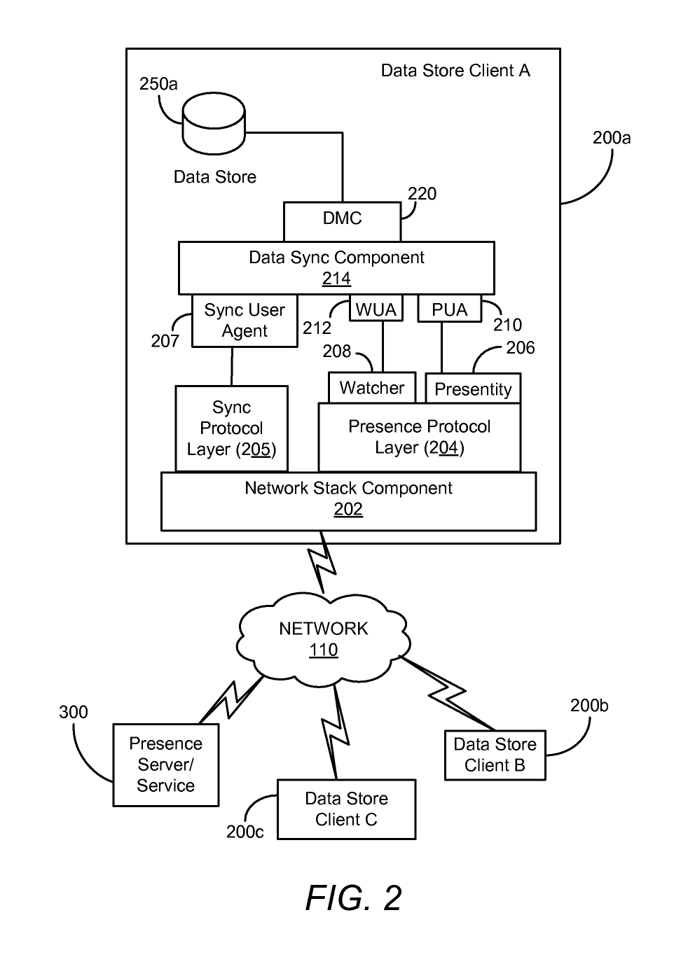

FIG. 2 is a block diagram of an exemplary data store client, e.g., 200a, according to one embodiment. The data store client 200a is a presence client configured to send and receive messages to and from the presence server/service 300 using a presence communication protocol. In one embodiment, the data store client 200a includes the data store 250a operatively coupled to a data manager component (DMC) 220, e.g., a database management system if the data store 250a is a database. The DMC 220 manages and organizes the data in the data store 250a and is configured to determine a change in the data store's content.

According to an exemplary embodiment, a data synchronization (sync) component 214 is operatively coupled to the DMC 220. The data sync component 214 is used to keep the content stored in the data store 250a in sync with the content in the other data store clients 200b, 200c via the presence server/service 300. In one embodiment, the data sync component 214 can publish presence information to and or a portion of the data in the data store 250a. In one embodiment, when the DMC 220 determines that content in all or a portion of the data store 250a has changed since a prior synchronization operation with another data store client, e.g., 200b, of the group, the data sync component 214 can set the status value to a first value that indicates that content in all or a portion of the data store 250a is “out-of-sync” with at least one other data store client 200b of the group. In other embodiments, the status value can be set to other values to indicate various states of synchronization, e.g., that the content of the data store 250a is “in-sync,” or that a synchronization operation is in progress. In one embodiment, the status value can include other related information. For example, the status value can include an identifier associated with a specific synchronization point, e.g., a timestamp, and identifiers of other data store clients 200b, 200c with which it is in-sync.

In one embodiment, the PUA 210 and the presentity component 206 are configured to generate a message compatible with a transmission format that includes a status element for carrying the status value. The message is then sent to the presence server/service 300 via the presence protocol layer 204 and network stack 202.

In one embodiment, the data sync component 214 can also send and receive synchronization messages, i.e., instructions, to and from other data store clients 200b, 200c in the group using a proprietary synchronization protocol via a sync protocol layer 205 and the network stack component 202. Such communications are independent from communications with the presence server/service 300, and can be referred to herein as “out-of-band” communications.

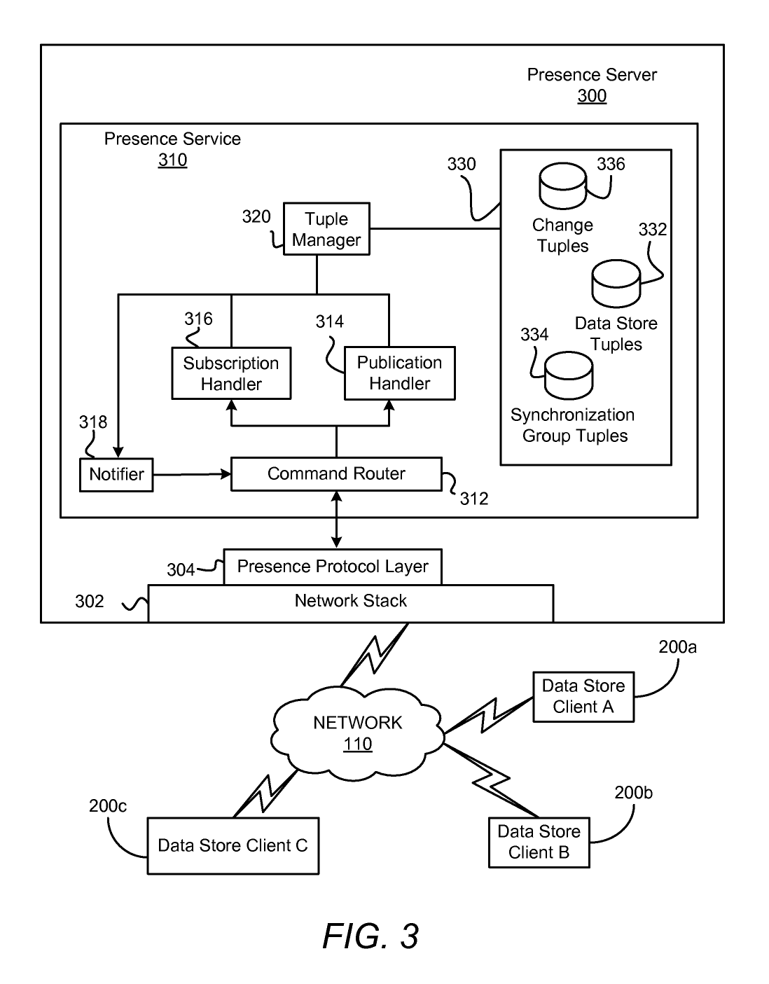

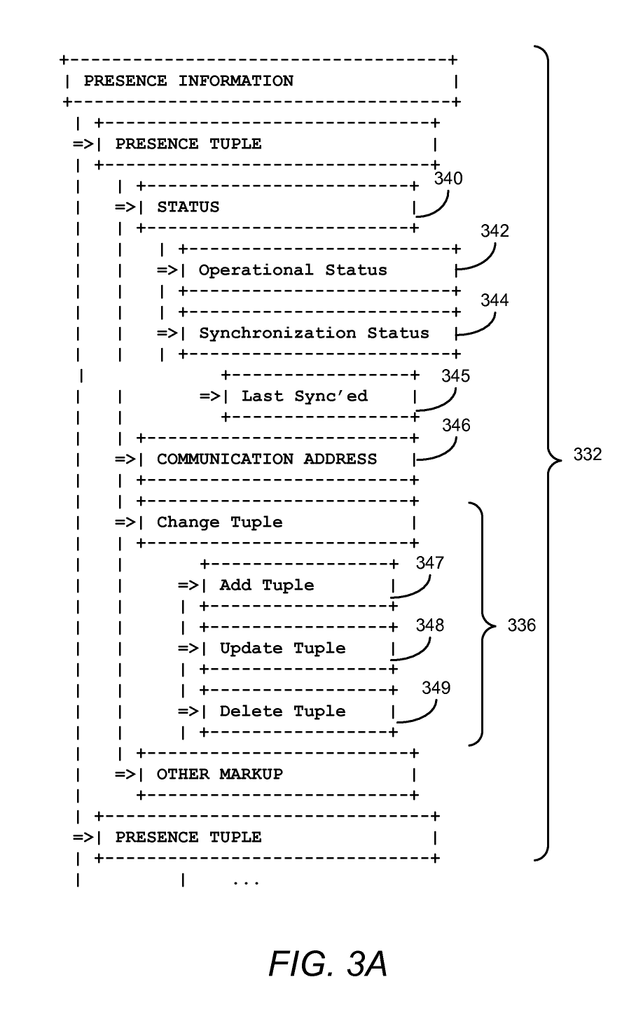

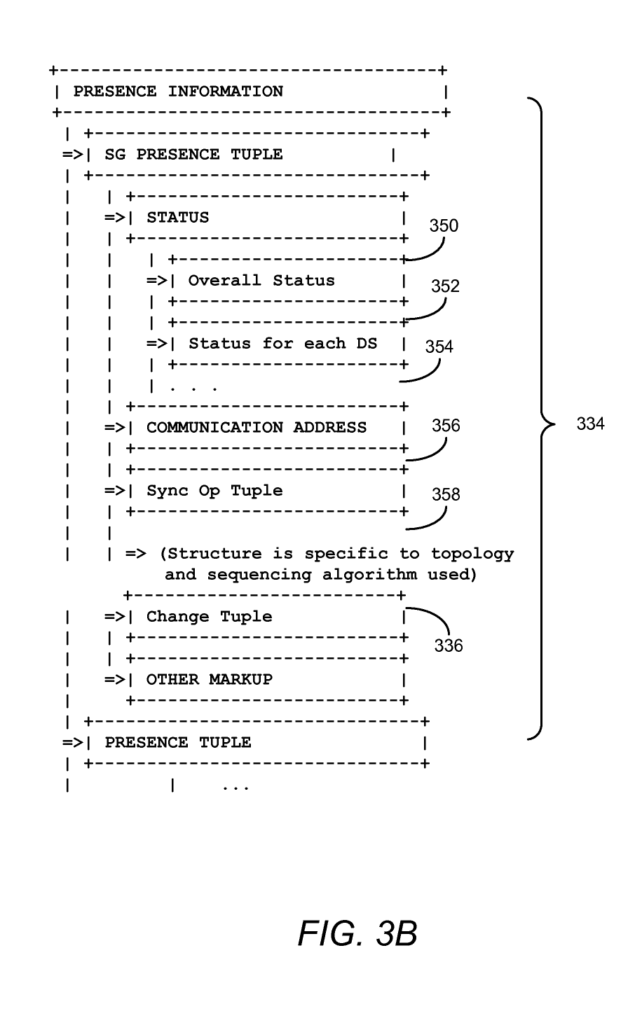

FIG. 3 is a block diagram of an exemplary presence server 300 according to one embodiment. The presence server 300 includes a presence service 310 that is configured to receive and send messages to presence clients, such as the data store clients 200a-200c, over the network 110 using a presence protocol layer 304 coupled to a network stack 302. In one embodiment, a message sent from a data store client 200a using a presence protocol is received by the presence server 300 via a communications port provided by the network stack 302. The network stack 302 routes the message to the presence protocol layer 304 which provides support for sending and receiving presence messages using a pub/sub protocol supported. Example protocols can include XMPP-IM presence protocol, SIP's SIMPLE presence protocol, and proprietary presence protocols such as those provided by MSN, AOL's AIM service, and Yahoo's IM service.

The presence service 310 includes means for receiving and processing presence commands, e.g., SUBSCRIBE and PUBLISH, from the presence protocol layer 304, means for handling subscribe commands, means for handling publish commands, and means for handling notification messages. For example, a command router component 312 can be configured to receive and process presence commands from the presence protocol layer 304. In one embodiment, the command router component 312 directs SUBSCRIBE commands to a subscription handler component 316, directs PUBLISH commands to a publication handler component 314, and sends notification messages on behalf of a notifier component 318. The command router component 312 can also be configured to process other presence commands, such as PROBE and FETCH/POLL.

The subscription handler component 316 processes SUBSCRIBE commands and other tasks associated with subscriptions. In one embodiment, the subscription handler component 316 processes a SUBSCRIBE command by placing a subscribing client, e.g., data store client A 200a, on a subscription list associated with a tuple or portions of a tuple. In addition, the subscription handler component 316 authenticates and authorizes the subscribing client 200a, manages rosters and subscription lists, and uses the notifier component 318 to construct notification messages informing subscribed clients 200a when updated tuple information is available.

The publication handler component 314 receives and processes PUBLISH commands. In an exemplary embodiment, the publication handler component 314 is configured to identify and process presence information that includes the status value in a PUBLISH command. In one embodiment, the publication handler component 314 can use the presence information to update or create a tuple identified in the message. Depending on the nature of the command, the publication handler component 314 can also pass the presence information directly to specified recipients via a directed notify command using the notifier component 318, or can pass the presence information to currently subscribed clients 200a, 200b using the subscription handler component 316 and notifier component 318.

In one embodiment, the presence service 310 includes a tuple manager 320 that manages data in a data store 330. The data can be organized in data files, memory caches and/or databases. In an exemplary embodiment, the tuple manager 320 treats some or all of the data as a tuple, such that the data can be formatted for transmission using a data format compatible with a presence protocol supported by the presence service 310.

According to an exemplary embodiment, the data store 330 includes data store tuples 332. A data store tuple 332 is associated with a data store client, e.g., data store client A (200a), in a group. The data store tuple 332 stores the current presence information of the associated data store client 200a and is addressable by a PUBLISH command of the presence service 310. In one embodiment, the data store tuple 332 includes a status element for storing the status value. As described above, the status value can indicate whether content in the associated data store client 200a has changed since a prior synchronization operation occurred with at least one other data store client 200b in the group.

In another embodiment, the data store 330 can include change tuples 336. Similar to the data store tuples 332, a change tuple 336 is associated with a data store client 200a in the group and stores change information comprising the current changes to the content of the data store 250a associated with the client 200a. The change tuple 336 is addressable by a PUBLISH command and in one embodiment includes a change element for storing the change information.

Although the change tuples 336 are shown as separate presence tuples in FIG. 3, the change tuples 336 can be sub-tuples of the data store tuples 332. For example, FIG. 3A illustrates an exemplary network data model of a data store tuple 332 according to one embodiment. The tuple 332 includes a status element 340 that can include a sub-element for the data store client's operational status 342, e.g., “off-line,” “active,” or “backing up,” and a sub-element for a synchronization status 344. The synchronization status sub-element 344 can include one or more elements 345 for storing synchronization related information, e.g., a timestamp identifying when a last synchronization operation has occurred, identifiers for other data store clients in the group, and other data.

In one embodiment, the operational status 342 can be used to trigger a synchronization operation. For example, when a change from a non-operational status value, e.g., “off-line,” to an operational status value occurs, a synchronization check can be performed to ensure the data store client 200a is at the latest sync point rather than waiting for an active data store client 200b in the group to publish a changed content synchronization status value. Other types of status values and additional fine grain operational 342 and synchronization status 344 elements may be provided to support a need by a particular synchronization mechanism.

The data store tuple 332 can include communication address elements 346 that provide addresses not only specifying different protocols and addresses, but also addresses categorized by service or function. For example, the synchronization user agent 207 of a data store client 200a may have one or more address elements associated with it, as well as priorities associated with each element.

According to one embodiment, the data store tuple 332 can include a change tuple 336 as a sub-tuple. As stated above, the change tuple 336 stores change information comprising the current changes to the content of the data store 250a associated with the client 200a since a prior synchronization, if any. In one embodiment, the change tuple 336 can include an add sub-tuple 347, an update sub-tuple 348, and a delete sub-tuple 349 for storing corresponding change elements. For example, if the content change associated with the status value 340 comprises deleting data, such change information can be stored in the delete tuple 349.

In this embodiment, the identifier of the last sync point 345 of the associated data store client 200a along with the change information elements 347-349 enable synchronization of another data store client 200b in the group at the identified last sync point from data in the change sub-tuple 336, thereby eliminating the need for interaction with the data store client 200a that published the change tuple 336.

Referring again to FIG. 3, in another embodiment, the data store 330 can include synchronization group tuples (group tuples) 334. In contrast to data store tuples 332, a group tuple 334 is associated with a group of at least two data store clients 200a-200c that have content that is to be kept in sync. The group tuple 334 specifies the synchronization requirements for the group and includes information for monitoring and tracking the synchronization operation of the associated synchronization group. For example, a group tuple 334 can specify the ordering of synchronization operations in a group comprising more than two data store clients 200a-200c. Additionally, the group tuple 334 can specify the manner in which a synchronization operation should be performed, e.g., using a hub-and-spoke system, a peer-to-peer system, a ring, or a hierarchy of data store clients, and can indicate which data store clients can serve as a hub.

FIG. 3B illustrates an exemplary data model of a group tuple 334 that can be used for transmission and/or storage of presence information according to one embodiment. The group tuple 334 includes a status sub-tuple 350 that includes an overall group status element 352 and status elements 354 for each data store client 200a-200c in the group. The status elements 354 can include an identifier for each data store client 200a-200c and a reference to the data store tuple 332 associated with each data store client 200a-200c rather than duplicating the status values. Communication address elements 356 providing synchronization addresses associated with the synchronization of the group can be provided as well. This may be a single address, for example, when a synchronization master is used, or there may be elements for accessing the synchronization user agents 207 of each data store client 200a-200c. The communication address information stored can depend on the topology of the group and the rules and policies of the synchronization operation.

In one embodiment, the group tuple 334 can include a synchronization operation sub-tuple 358. The synchronization operation sub-tuple 358 can store the information that indicates how the synchronization operation is to be performed, as discussed above. In addition, the group tuple 334 can also include a change sub-tuple 336 that stores change information since the last sync point of the group.

Referring again to FIG. 3, in one embodiment, the publication handler component 314 can use the tuple manager 320 to update or create the tuples 332, 334, 336 described above. In response to the update, the subscription handler component 316 determines where notifications are to be sent, and what content the notifications should have for each notified entity. Notifications sent over the network 110 are constructed by the notifier component 318 using notification and watcher information provided via the subscription handler component 316. The notifier component 318 communicates with the command router component 312 enabling the command router component 312 to format the notification data in a manner compatible with the supported presence protocol and the interface provided by the presence protocol layer 304.

In one exemplary embodiment, a data store client 200b in a group is subscribed to a data store tuple 332 associated with at least one other data store client 200a in the group. The subscribed data store client 200b can be subscribed to one or more portions of the data store tuple 332, such as the status sub-tuple 340. Thus, when the status value in the status sub-tuple 340 is updated by the publication handler component 314, the subscription handler 316 and notifier 318 can create and send a notification message including the updated status value to the subscribed data store client 200b.

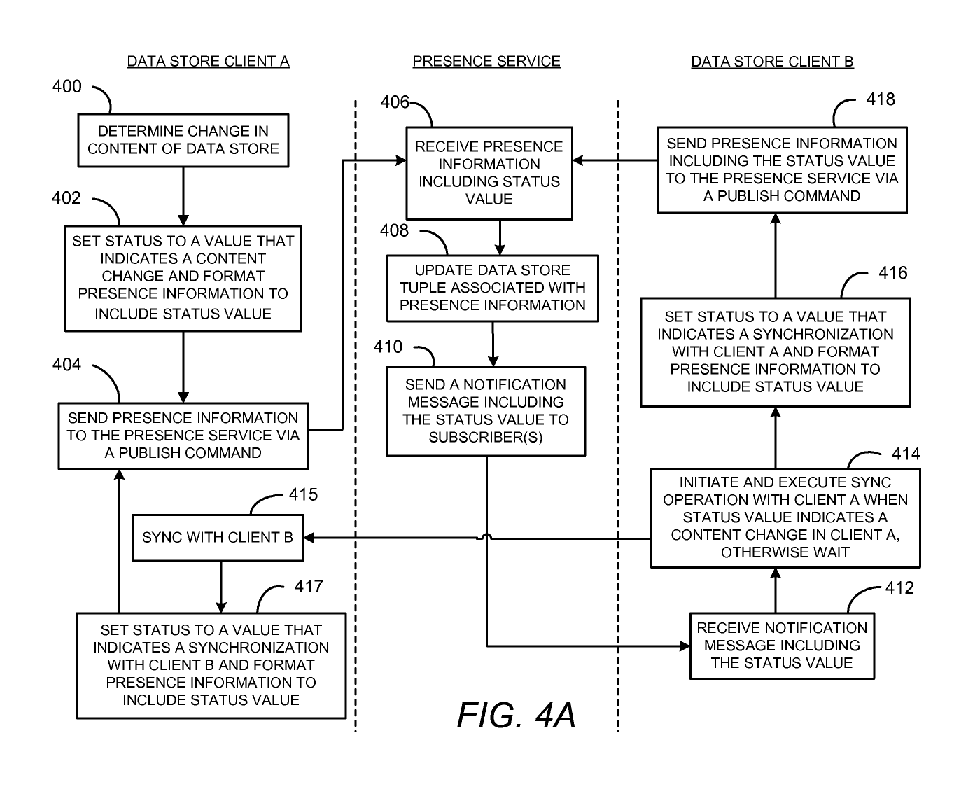

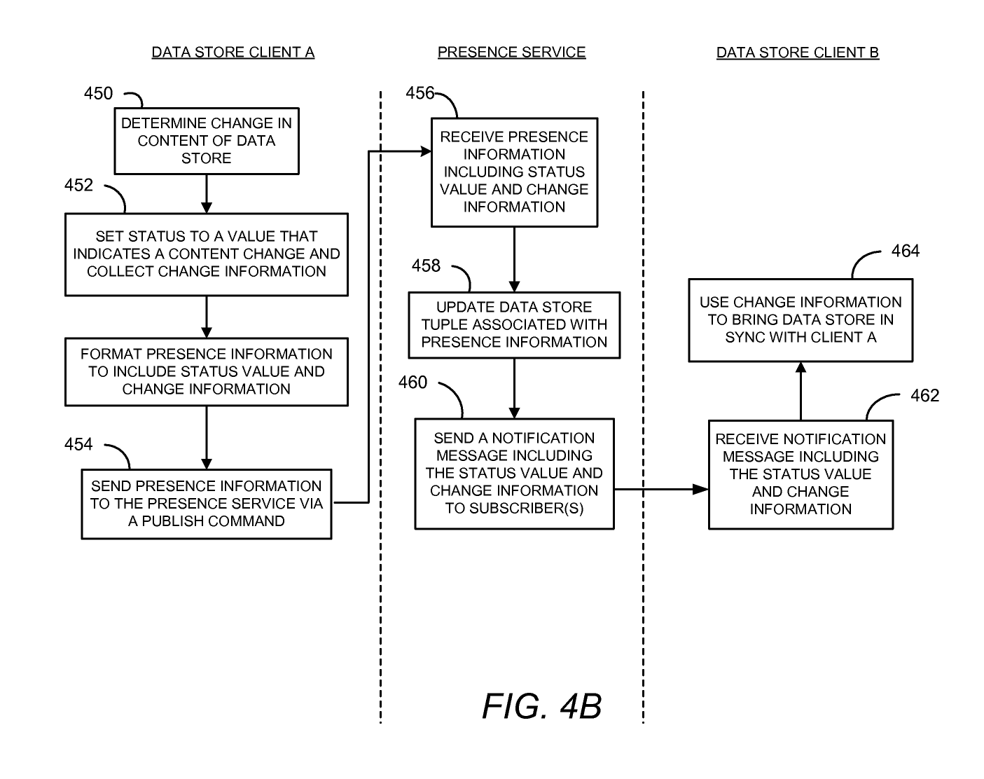

FIG. 4A is a flow diagram illustrating an exemplary process for synchronizing data according to one embodiment. In this embodiment, data store client A (client A) 200a and data store client B (client B) 200b are presence clients in a group in which the content in each data store 250a, 250b is to be kept in sync. Referring to FIG. 2 and FIG. 4A, the process begins when client A 200a determines a change in content of its data store 250a (block 400). In one embodiment, the DMC 220 in client A 200a determines a content change by deleting data from, updating existing data in, and/or adding data to the data store 250a. When a content change is determined, the DMC 220 invokes the data sync component 214. In response, the data sync component 214 sets a status value to a first value indicating that content in the data store 250a has changed since a prior synchronization operation has occurred with client B 200b and uses the PUA 210 to format presence information to include the status value (block 402). In one embodiment, the first value can be a timestamp indicating when the change occurred.

A message including the presence information is then sent to the presence server/service 300 via publish command (block 404). In an exemplary embodiment, the publish command is compatible with a transmission format which provides a status element for carrying the status value. The message is passed from the presentity 206 to the presence protocol layer 204 for transmission to the presence server/service 300 via the network 110 using the network stack 202.

Referring now to FIG. 3 and FIG. 4A, the presence service 310 receives the message including the presence information and the first status value via the presence protocol layer 304 and network stack 302 (block 406). The command router component 312 directs the publish command to the publication handler component 314 which uses the tuple manager 320 to update the data store tuple 332 associated with the received presence information (block 408). In one embodiment, the status sub-tuple 340 (FIG. 3A) of the data store tuple 332 is updated with the first status value.

In response to such an update, the subscription handler component 316 determines which entities are subscribed and available to receive notifications related to the update, and then uses the notifier component 318 to send a notification message including at least a portion of the presence information and the updated status value to subscribed clients, including client B 200b (block 410). In one embodiment, the notifier 318 creates a notification request and passes the request to the command router component 312, which formats the request to comply with the presence protocol. The notification message is then passed to the presence protocol layer 304 and transmitted to client B 200b via the network 110 using the network stack 302.

Referring again to FIGS. 2 and 4, client B 200b receives the notification message that includes the first status value from the presence service 300 via the presence protocol layer 204 and network stack 202 (block 412). In one embodiment, the notification message is received by the watcher 208, which then routes the notification message to the subscribed WUA 212. The WUA 212 processes the message and passes the status value to the data sync component 214.

According to an exemplary embodiment, the data sync component 214 initiates and executes a synchronization operation with client A 200a when the value of the received status element indicates that content in client A 220a has changed (block 414). For example, when the received status value is a timestamp that is more recent than the timestamp indicating when a last synchronization has occurred, the received status value indicates that content in client A 220a has changed.

The synchronization operation between client A 200a and client B 200b can be implemented in many ways. In one embodiment, client B 200b can use its sync user agent 207 to send an “out-of-band” message to client A 200a requesting to initiate a receive notifications of the same from the presence service 300 via a presence protocol layer 204 and a network stack component 202. The network stack component 202 is used to exchange information received or transmitted at the physical layer (e.g., the wire, air interface, or fiber optic cable) of the network 110, through the data link (e.g., ETHERNET, 802.11 WIFI), transport/network (e.g., TCP/IP) and application (e.g., XMPP) layers of the stack. The presence protocol layer 204 processes messages received from the presence service 300 over the network 110.

In one embodiment, the data sync component 214 publishes outgoing presence information to the presence service 300 via a presentity component 206. The data sync component 214 can utilize a presentity user agent (PUA) 210 to format outgoing presence information for the presentity component 206. Incoming notification messages that include presence information are received by a watcher component 208, which can route the presence information to the data sync component 214. The data sync component 214 can utilize a watcher user agent (WUA) 212 to translate incoming presence information from the watcher component 208. In addition, the data sync component 214 can use the watcher component 208 to request a subscription to receive notifications relating to the presence information of other data store clients 200b, 200c in the group. A more detailed description of the presentity 206 and the watcher 208 components and the user agents (210, 212) is provided in RFC 2778 cited above.

In an exemplary embodiment, the presence information published by the data sync component 214 includes a status value that reflects the synchronization state of all synchronization operation, and in response to granting client B's request, client A 200a can execute the synchronization operation with client B 200b (block 415). In this embodiment, client A 200a and client B 200b are peers that communicate directly with one another, and the presence service 300 is not involved in the synchronization operation.

In another embodiment, illustrated in FIG. 4B, client B 200b is not required to communicate with client A 200a because the synchronization operation is implemented using “in-band” messages with the presence service 300. In this embodiment, referring to FIG. 4B, client A 200a determines a content change in its data store 250a, as discussed above (block 450). In response, the data sync component 214 sets the status value to the first value and collects change information from the DMC 220 (block 452). As stated above, the change information comprises the changed content of the data store 250a. The data sync component 214 uses the PUA 210 to format presence information to include the status value and the change information (block 453). A message including the presence information is then sent to the presence server/service 300 via a publish command (block 454). In an exemplary embodiment, the publish command is compatible with a transmission format which provides a status element for carrying the status value and a change element for carrying the change information.

The presence service 310 receives the presence information that includes the status value and the change information via the presence protocol layer 304 and network stack 302 (block 456). The publication handler component 314 can update the data store tuple 332 and the change tuple 336 associated with client A 200a (block 458) and the subscription handler component 316 can send a notification that includes the status value and the change information to client B 200b based on client B's subscription to client A's data store tuple 332 and change tuple 336 (block 460). Upon receiving the notification that includes the status value and the change information (block 462), client B 200b can use the change information to synchronize the content of its data store 250b (block 464). In this embodiment, client B 200b is not required to communicate with client A 200a, and the synchronization operation is implemented entirely with “in-band” messages sent to and from the presence service 300.

Other processes for using a presence service 310 to synchronize data can be utilized where some communications are “out-of-band” and other communications are “in-band.” At a minimum, however, the presence service 310 is used to publish the value of the status element associated with the publishing data store client to other interested clients thereby enabling the other interested clients to initiate a synchronization operation if necessary.

Referring again to FIG. 4A, in one embodiment, once the synchronization operation is initiated or completed, the data sync component 214 in client B 200b sets the value of the status element to a second value indicating a synchronization with client A 200a is in progress or has occurred and uses the PUA 210 to format presence information to include the status value (block 416). Similarly, the data sync component 214 in client A 200a sets the value of the status element to the second value indicating a synchronization with client B 200b is in progress or has occurred and uses the PUA 210 to format presence information to include the status value (block 417). Messages including the presence information and the second value are then sent to the presence server/service 300 via a publish command (block 404, block 418).

According to the embodiments described above, each data store client 200a-200c is configured to at least send presence information to the presence service 310. In one embodiment, each data store client 200a-200c can be associated with a data store tuple 332, and each data store client, e.g., 200a, can be subscribed to receive notifications relating to each of the other data store tuples 332. In another embodiment, different synchronization topologies, i.e., the manner in which the synchronization operation is implemented, can be created by selectively subscribing data store clients 200a-200c to data store tuples 332. This can be particularly useful for synchronizing a group that comprises a large number of data store clients 200a-200c.

For example, a ring synchronization topology can be created by identifying a data store client, e.g., 200a, to be a ring start. The ring start can be subscribed to the data store tuples 332 for each of the other clients 200b, 200c in the group. Then, a first data store client 200b can be subscribed to the data store tuple 332 associated with the ring start 200a, a second data store client 200c can be subscribed to the data store tuple 332 associated with the first data store client 200b and so forth for the remaining clients in the group.

In another example, a hub and spoke topology can be created by identifying a data store client, e.g., client A 200a, to be the hub or master data store client. In this embodiment, a data store client, e.g., 200b, that publishes a changed content status value synchronizes with the master 200a. Thereafter, the master 200a brings the remaining data store clients 200c in the group up to the latest synchronization point.

In one embodiment, the master 200a subscribes to the data store tuples 332 of the other data store clients 200b, 200c in the group. Each data store client 200a-200c publishes a content changed status value when appropriate. When the master 200a receives a content changed notification, it initiates a synchronization operation with the publishing data store client 200b. The synchronization operation can be implemented through direct communication with the publishing client 200b, i.e., “out-of-band,” or through the presence service 310 using a change tuple 336. In one embodiment, the master 200a and/or the publishing data store client 200b can publish presence information including status information indicating the both data stores are in sync and associated with an identified sync point. The master 200a can then bring the remaining data store clients 200c in the groups into synchronization.

Other topology models, such as hierarchical cascades, can be implemented singularly or in combination. Multiple rings, hubs, and cascades can also be implemented to allow parallel data synchronization.

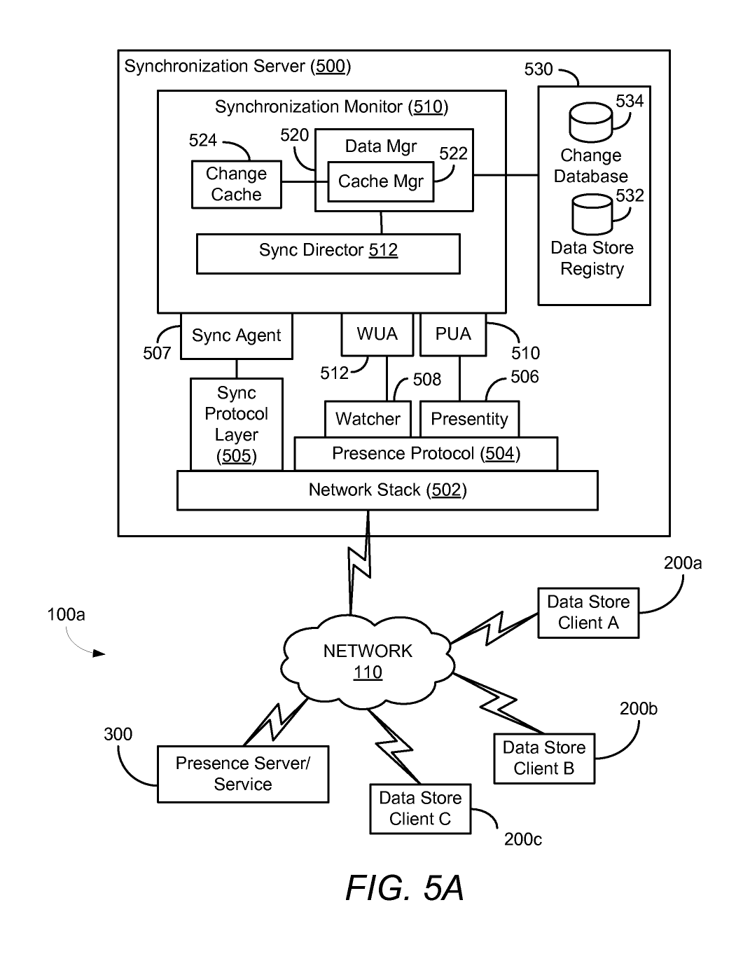

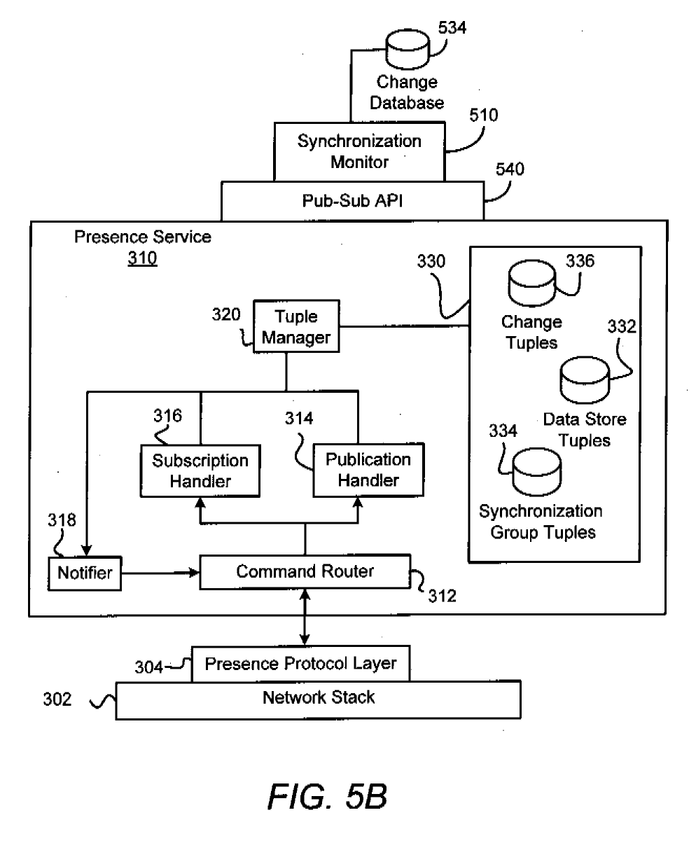

According to another exemplary embodiment, shown in FIG. 5A, the synchronization system 100a can include a synchronization server 500 coupled to the network 110. The synchronization server 500 is configured to communicate with the presence server/service 300 and with the data store clients 200a-200c, either directly or via the presence server/service 300. In an exemplary embodiment, the synchronization server 500 is configured to manage and track a synchronization operation between the data store clients 200a-200c in one or more groups.

In one embodiment, the synchronization server 500 hosts a synchronization monitor 510 that includes a sync director 512 operatively coupled to a data manager 520, which manages and organizes data in a data store 530. In one embodiment, the data store 530 can include a data store registry 532 that includes the data store tuples 332 and the synchronization group tuples 334 described above. In another embodiment, the data store 530 can include a change database 534 that includes information related to the synchronization status of the data store clients 200a-200c. For example, the change database 534 can include change logs and associated change information for each data store client 200a-200c, as well as the change tuples 336 associated with the data store clients 200a-200c.

In one embodiment, the sync director 512 uses the information stored in the data store 530 to handle synchronization operations between data store clients 200a-200c in one or more groups. For example, the sync director 512 can use a group tuple 334 to determine: which data store clients to involve in a synchronization operation; the ordering of synchronization among the group members; and the topology of the synchronization operation, e.g., ring, hub or spoke. In addition, the sync director 512 can enforce rules and policies associated with the synchronization of a group.

In one embodiment, the data manager 522 can retrieve and temporarily store change information from the change database 534 in a change cache 524. In this embodiment, a cache manager 522 can quickly retrieve change information from the change cache 524 during a synchronization operation thereby improving performance.

According to an exemplary embodiment, the synchronization monitor 510 is a presence client. Similar to other presence clients, the synchronization monitor 510 communicates with a presence server/service 300 via the network 110 using a network stack 502. The synchronization monitor 510 uses a watcher 508 to process subscription requests sent to, and notifications received from, the presence server/service 300, and a presentity 506 for publishing tuple updates. A WUA 512 and a PUA 510 serve as interfaces to the underlying command protocol for the synchronization monitor 510 communicating with the watcher 508 and presentity 506 respectively. In another embodiment, the synchronization monitor 510 can send and receive “out-of-band” synchronization messages, e.g., instructions, to and from the data store clients 200a-200c in a group using a proprietary synchronization protocol via a sync protocol layer 505 and the network stack 502.

In another embodiment, illustrated in FIG. 5B, the synchronization monitor 510 can be integrated with the presence service 310 via a pub/sub application program interface 540 that supports applications built using the presence service 310 as a platform. In this embodiment, the pub/sub API 540 enables communication between the synchronization monitor 510 and the presence service 310 within the same processing space. In addition, because the synchronization monitor 510 is integrated with the presence service 310, the synchronization monitor 510 can use the tuple manager 320 to retrieve information from the data store 330 and a separate data store associated with the synchronization monitor 510 is not required. In one embodiment, the synchronization monitor 510 can build and maintain a change database 534 using the change tuples 336.

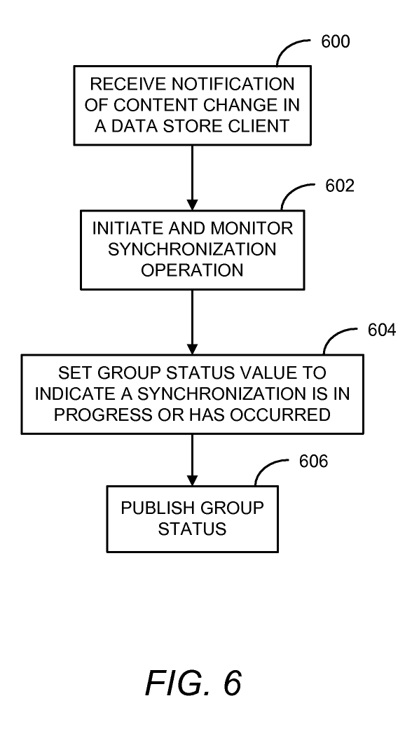

FIG. 6 is a flow diagram illustrating an exemplary process for synchronizing data using a synchronization monitor 510 according to one embodiment. Referring to FIG. 5A and FIG. 5B, when a data store client, e.g., 200a, publishes an updated status value that indicates a change in content since a prior synchronization operation has occurred, if any, the synchronization monitor 510 is notified of the update (block 600). In one embodiment, where the synchronization monitor 510 is a presence client and is subscribed to the status element of the data store tuple 332 associated with each data store client 200a-200c, the synchronization monitor 510 can receive a notification message as a result of the subscription it maintains to the data store tuple 332 associated with the publishing data store client 200a. Alternatively, where the synchronization monitor 510 is integrated with the presence service 310, it may be invoked directly by the presence service 310 through the pub/sub API 540.

In response to receiving the notification that includes the status value that indicates a change in content, the sync director 512 identifies which data store clients need to be synchronized and initiates and monitors a synchronization operation between the identified data store clients 200a-200c in the group (block 602).

The manner in which the sync director 512 implements the synchronization operation can vary depending on several factors such as bandwidth, the number of data store clients involved, the intelligence of the data store clients, and other factors. In one embodiment, the sync director 512 can select a first data store client 200b that is “out-of-sync” and send a message providing access information to a data store client 200a that is “in sync.” The first data store client 200b can then request synchronization with the “in sync” data store client 200a directly.

Conversely, the sync director 512 can send a message to the “in sync” data store client 200a that includes access information associated with the first data store client 200b, and the “in sync” data store client 200a can initiate a synchronization operation to synchronize the two data stores 250a, 250b. In this embodiment, the sync director 512 can send the message directly to one or both data store clients 200a, 200b or can provide the information via the presence service 310 by, for example, publishing information to a tuple resulting in a notification to one or both data store clients 200a, 200b initiating the synchronization operation. Notification can be directed or each data store client 200a, 200b can receive such notifications via a subscription.

In another embodiment, the synchronization monitor 510 can receive a notification message that includes the status value as well as change information as a result of the subscription it maintains to the data store tuple 332 and change tuple 336 associated with the publishing data store client 200a. In this embodiment, the sync director 512 can store the change information in its change database 534. The sync director 512 can select a data store client, 200b, that is “out-of-sync” and send a message providing the change information to the “out-of-sync” client 200b and instruct the client 200b to use the change information to bring the content of the data store 250b “in sync” with others in the group. In this embodiment, the synchronization monitor 510 can bring each data store client 200a-200c into a synchronized state without requiring communication among the data store clients 200a-200c.

This embodiment can be advantageous where members of a synchronization group are not continuously accessible via the network 110, such as mobile data store clients. In addition, the sync director 512 can implement the synchronization operation entirely “out-of-band,” i.e., synchronization messages to the data store clients 200a-200c can be sent and received using the sync user agents 207, 507. In this embodiment, the data store clients 200a-200c only need a presentity 206 and a PUA 210 to publish presence information to the presence service 310. A watcher 208 and WUA 212 are not needed because the clients 200a-200c are not receiving notifications.

In another embodiment, when the synchronization monitor 510 is notified of the change in content of a data store client 200a, it can retrieve from the publishing client 200a the change information. The sync director 512 can format presence information to include the change information and send the presence information to the presence service 310 via a publish command compatible with a transmission format that provides a change element for carrying the change information. In one embodiment, the publication handler component 314 can store the change information in a change sub-tuple 336 in a group tuple 334 associated with the publishing data store client 200a. When the other data store clients 200b, 200c in the group are subscribed to the change tuple 336 in the group tuple 334, the subscribing data store clients 200b, 200c can receive a notification that includes the change information.

As stated above, the ways in which the synchronization operation can be implemented are varied. The embodiments above are illustrative, but certainly not intended to be limiting.

Referring again to FIG. 6, once the synchronization operation is initiated or completed, the sync director 512 sets the value of a status element associated with the group to a value indicating a synchronization is in progress or has occurred (block 604). The sync director 512 can then publish the group status to the presence service 310 (block 606). In one embodiment, the sync director 512 uses the PUA 510 to format presence information to include the group status value, while in another embodiment, a message including the group status value is transmitted to the presence service 310 through the pub/sub API 540.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

Moreover, the executable instructions of a computer program as illustrated in FIG. 4 and FIG. 6 can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Methods and systems for synchronizing data using a presence service have been described. It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method of synchronizing data using a presence service, the method comprising:
receiving, via a presence service, a first message including presence information from a first data store client of a group of data store clients, the first message compatible with a transmission format including a status element for carrying a first status value indicating that content in the first data store client has changed since a prior synchronization operation, if any, occurred with a second data store client of the group; and
in response to receiving the first message, sending a second message that enables a synchronization operation to occur for synchronizing content of the first data store client and the second data store client based on the change in the content of the first data store client.

2. The method of claim 1 comprising:
creating and maintaining a data store tuple for at least one of the data store clients in the group; and
associating the presence information from the at least one data store clients with the data store tuple;
wherein the data store tuple is addressable by a publish command of the presence service and has a corresponding status element for storing a status value indicating whether content in the at least one data store client has changed since a prior synchronization operation, if any, occurred with at least one other data store client in the group.

3. The method of claim 2 comprising:
subscribing another data store client in the group to receive notifications via the presence service related to the status element of the data store tuple associated with the at least one data store client.

4. The method of claim 3 wherein the data store tuple is associated with the first data store client, the second data store client is subscribed to the status element of the data store tuple, the status value is the first status value, and sending the second message that enables the synchronization operation to occur comprises:
sending a notification, via the presence service, including at least a portion of the presence information associated with the data store tuple including the first status value to the subscribed second data store client via a notify command compatible with the transmission format to notify the second data store client of the change in the data content of the first data store client.

5. The method of claim 4 comprising:
receiving change information comprising the changed content of the first data store client from the first data store client via a publish command capable of sending the change information as presence information compatible with the transmission format providing a change element for carrying the change information.

6. The method of claim 5 comprising:
creating and maintaining a change tuple for the first data store client when the change information is generated by the first data store client; and
associating the presence information including the change information with the change tuple;
wherein the change tuple is addressable by a publish command of the presence service and has a structure corresponding to the transmission format including a corresponding change element for storing the change information.

7. The method of claim 6 comprising:
subscribing the second data store client to receive notifications, via the presence service, related to the change element of the change tuple associated with the first data store client; and
sending a notification including at least a portion of the presence information associated with the change tuple including the change information to the subscribed second data store client via a notify command capable of sending the notification in conformance with the transmission format.

8. The method of claim 1, comprising receiving, via the presence service, a third message including presence information from at least one of the first data store client and the second data store client, the third message compatible with the transmission format and including a second status value, carried by the status element, indicating a synchronization of the content of the first data store client and the second data store client based on the change in the content of the first data store client.

9. The method of claim 2 comprising:
providing a synchronization monitor in communication with the presence service, wherein the synchronization monitor tracks a synchronization progress of the synchronization operation.

10. The method of claim 9 wherein the synchronization monitor is a client of the presence service and the method comprises:
subscribing the synchronization monitor to the status element of the data store tuple associated with the at least one data store client in the group.

11. The method of claim 10 wherein the data store tuple is associated with the first data store client, the status value is the first status value, and sending the second message that enables the synchronization operation comprises:
sending a notification, via the presence service, including at least a portion of the presence information associated with the data store tuple including the first status value to the subscribed synchronization monitor via a notify command compatible with the transmission format to notify the synchronization monitor of the change in the data content of the first data store client.

12. The method of claim 9 wherein providing the synchronization monitor includes providing an application program interface that allows the presence service to interact directly with the synchronization monitor.

13. The method of claim 12 wherein sending the second message that enables the synchronization operation comprises:
using, by the presence service, the application program interface to invoke the synchronization monitor; and
sending a notification including at least a portion of the presence information associated with the data store tuple including the first status value to the synchronization monitor via the application program interface to notify the synchronization monitor of the change in the data content of the first data store client.

14. The method of claim 9 comprising:
receiving change information based on the changed content of the first data store client from the synchronization monitor via a publish command capable of sending the change information as presence information compatible with the transmission format providing a change element for carrying the change information;
creating and maintaining a group tuple for the group; and
associating the presence information including the change information with the group tuple;
wherein the group tuple is addressable by a publish command of the presence service and has a structure corresponding to the transmission format including a group status element for storing a status of the group, a status element associated with each data store client in the group for storing the value of a status element of a data store client in the group, and a change element for carrying the change information.

15. The method of claim 14 comprising:
subscribing at least two data store clients in the group to the change element of the group tuple; and
sending a notification including at least a portion of the presence information associated with the group tuple including the change information to the subscribed data store clients via a notify command capable of sending the notification in conformance with the transmission format.

16. A method of synchronizing data content in a first data store client with data content in a second data store client using a presence service, the method comprising:
determining, by the first data store client, a change in data content of the first data store client and setting a value of a status element to a first status value indicating that data content in the first data store client has changed since a prior synchronization operation, if any, occurred with the second data store client; and
sending, by the first data store client, a first message including presence information and the first value to a presence service via a publish command capable of sending the presence information including the first value compatible with a transmission format providing a status element for carrying the first value.

17. The method of claim 16 wherein a data store tuple is created and maintained by the presence service for the first data store client, the presence information including the first status value is associated with the data store tuple, and the data store tuple is addressable by a publish command of the presence service and has a structure compatible with the transmission format having a corresponding status element for storing the first status value.

18. The method of claim 17 comprising:
requesting, by the second data store client, a subscription to receive notifications via the presence service related to the status element of the data store tuple associated with the first data store client;
receiving, by the second data store client, a notification including at least a portion of the presence information associated with the data store tuple including the first status value via a notify command compatible with the transmission format to notify the second data store client of the change in data content of the first data store client; and
in response to receiving the notification, initiating and executing the synchronization operation.

19. The method of claim 18 wherein initiating the synchronization operation comprises:
sending a synchronization request from the second data store client to the first data store client; and
executing the synchronization operation between the first data store client and the second data store client when the request is granted.

20. The method of claim 18 comprising:
sending, by the first data store client, change information comprising the changed content of the first data store client to the presence service via a publish command capable of sending the change information as presence information compatible with the transmission format providing a change element for carrying the change information;
wherein a change tuple associated with the first data store client is created and maintained by the presence service when the change information is generated by the first data store client, the presence information including the change information is associated with the change tuple, and the change tuple is addressable by a publish command of the presence service and has a structure corresponding to the transmission format including a corresponding change element for storing the change information.

21. The method of claim 20 comprising:
requesting, by the second data store client, a subscription to receive notifications via the presence service related to the change element of the change tuple associated with the first data store client;
receiving, by the second data store client, a notification including at least a portion of the presence information associated with the change tuple including the change information via a notify command capable of sending the notification in conformance with the transmission format; and
using the change information in the change element to synchronize the data content of the second data store client with the first data store client.

22. The method of claim 16 comprising:
receiving, by at least one of the first data store client and the second data store client, a synchronization command from a synchronization monitor, wherein the synchronization monitor tracks a synchronization progress of a synchronization operation; and
in response to receiving the command, initiating and executing the synchronization operation.

23. The method of claim 16 comprising sending a second message to the presence service including presence information, the second message compatible with the transmission format and including a second status value, carried by the status element, indicating a synchronization of the content of the first data store client and the second data store client based on the change in the content of the first data store.

24. A system for synchronizing data in a group of data store clients using a presence service, the method comprising:
a data store for storing presence information including status information; and
at least one presence server including a presence service and a network protocol stack component having a presence protocol layer for communicating with at least one presence service client, the presence service including:
a publication handler component, operatively coupled to the data store, configured to receive a first message including presence information from a first data store client of a group of data store clients, the first message compatible with a transmission format including a status element for carrying a first status value indicating that content in the first data store client has changed since a prior synchronization operation, if any, occurred with a second data store client of the group;
a notify component operatively coupled to the data store, configured to send a second message that enables a synchronization operation to occur for synchronizing content of the first data store client and the second data store client based on the change in the content of the first data store client in response to receiving the status element comprising the first value from the first data store client; and
a command router component, operatively coupled to the publication handler and notify components and to the network protocol stack component, the command router component configured to route the first message and second message between publication handler and notify components.

25. The system of claim 24 wherein the presence service is configured to:
create and maintain a data store tuple for at least one of the data store clients in the group; and
associate the presence information from the at least one data store client with the data store tuple;
wherein the data store tuple is addressable by a publish command of the presence service and has a corresponding status element for storing a status value indicating whether content in the at least one data store client has changed since a prior synchronization operation, if any, occurred with at least one other data store client in the group.

26. The system of claim 25 wherein the presence service includes a subscription handler component, operatively coupled to the publication handler and notify components and to the command router component, the subscription handler component configured to subscribe another data store client in the group to receive notifications via the presence service related to the status element of the data store tuple associated with the at least one data store client.

27. The system of claim 26 wherein when the data store tuple is associated with the first data store client, the second data store client is subscribed to the status element of the data store tuple, and when the status value is the first status value, the notify component is configured to send a notification including at least a portion of the presence information associated with the data store tuple including the first status value to the subscribed second data store client via a notify command compatible with the transmission format to notify the second data store client of the change in the data content of the first data store client.

28. The system of claim 27 wherein the publication handler component is configured to receive change information comprising the changed content of the first data store client from the first data store client via a publish command capable of sending the change information as presence information compatible with the transmission format providing a change element for carrying the change information.

29. The system of claim 28 wherein the presence service is configured to:
create and maintain a change tuple for the first data store client when the change information is generated by the first data store client; and
associate the presence information including the change information with the change tuple;
wherein the change tuple is addressable by a publish command of the presence service and has a structure corresponding to the transmission format including a corresponding change element for storing the change information.

30. The system of claim 29 wherein the subscription handler component is configured to subscribe the second data store client to receive notifications related to the change element of the change tuple associated with the first data store client, and the notify component is configured to send a notification including at least a portion of the presence information associated with the change tuple including the change information to the subscribed second data store client via a notify command capable of sending the notification in conformance with the transmission format.

31. The system of claim 25 comprising a synchronization monitor operatively coupled to the presence service, wherein the synchronization monitor tracks a synchronization progress of the synchronization operation.

32. The system of claim 31 wherein the synchronization monitor is a client of the presence service and hosted by a server that includes a network protocol stack component having a presence protocol layer for communicating with the presence service and wherein the subscription handler component is configured to subscribe the synchronization monitor to the status element of the data store tuple associated with the at least one data store client in the group.

33. The system of claim 32 wherein the data store tuple is associated with the first data store client, the status value is the first status value, and the notify component is configured to send a notification including at least a portion of the presence information associated with the data store tuple including the first status value to the subscribed synchronization monitor via a notify command compatible with the transmission format to notify the synchronization monitor of the change in the data content of the first data store client.

34. The system of claim 31 comprising an application program interface operatively coupling the synchronization monitor and the presence service such that the presence service interacts directly with the synchronization monitor.

35. The system of claim 34 wherein the publication handler component is configured to invoke the synchronization monitor via the application program interface and the notify component is configured to send a notification including at least a portion of the presence information associated with the data store tuple including the first status value to the synchronization monitor via the application program interface to notify the synchronization monitor of the change in the data content of the first data store client.

36. The system of claim 31 wherein the publication handler component is configured to receive change information based on the changed content of the first data store client from the synchronization monitor via a publish command capable of sending the change information as presence information compatible with the transmission format providing a change element for carrying the change information, and the presence service is configured to create and maintain a group tuple for the group, and to associate the presence information including the change information with the group tuple, wherein the group tuple is addressable by a publish command of the presence service and has a structure corresponding to the transmission format including a group status element for storing a status of the group, a status element associated with each data store client in the group for storing the value of a status element of a data store client in the group, and a change element for carrying the change information.

37. The system of claim 36 wherein the subscription handler component is configured to subscribe at least two data store clients in the group to the change element of the group tuple, and the notify component is configured to send a notification including at least a portion of the presence information associated with the group tuple including the change information to the subscribed data stores via a notify command capable of sending the notification in conformance with the transmission format.

38. A data server comprising:
a data store;
a data manager component for managing data content in the data store and for determining a change in content in the data store;
a data synchronization component, operatively coupled to the data manager component, configured to set a value of a status element to a first value indicating that content in the data store has changed since a prior synchronization operation, if any, occurred with another data store;
a network protocol stack component having a presence protocol layer configured to communicate with a presence service; and
a presentity component, operatively coupled to the data synchronization component and to the network protocol stack component, the presentity component configured to send a first message including presence information and the first value to the presence service via a publish command capable of sending the presence information including the first value compatible with a transmission format providing a status element for carrying the first value.

39. The data server of claim 38 comprising at least one presence user agent component configured to format the presence information to include the value of the status element.

40. The data server of claim 39 wherein a data store tuple is created and maintained by the presence service for the data server, the presence information including the first status value is associated with the data store tuple, and the data store tuple is addressable by a publish command of the presence service and has a structure compatible with the transmission format having a corresponding status element for storing the first status value.

41. The data server of claim 40 comprising:
a watcher component, operatively coupled to the data synchronization component and to network protocol stack component, the watcher component configured to request a subscription to receive notifications via the presence service related to a status element of a second data store tuple associated with a second data store, and to receive a notification including at least a portion of the presence information associated with the second data store tuple including the first status value via a notify command compatible with the transmission format to notify the data store of a change in data content of the second data store, wherein when the value is the first value, the data synchronization component is configured to initiate and execute a synchronization operation.

42. The data server of claim 41 wherein the data synchronization component is configured to send a synchronization request to the second data store and to execute the synchronization operation with the second data store when the request is granted.

43. The data server of claim 41 wherein the presentity component is configured to send change information comprising changed content of the data store to the presence service via a publish command capable of sending the change information as presence information compatible with the transmission format providing a change element for carrying the change information, and wherein a change tuple associated with the data server is created and maintained by the presence service when the change information is sent by the data server, the presence information including the change information is associated with the change tuple, and the change tuple is addressable by a publish command of the presence service and has a structure corresponding to the transmission format including a corresponding change element for storing the change information.

44. The data server of claim 43 wherein the watcher component is configured to request a subscription to receive notifications via the presence service related to a change element of a second change tuple associated with the second data store and to receive a notification including at least a portion of the presence information associated with the second change tuple including the changed content of the second data store via a notify command capable of sending the notification in conformance with the transmission format.

45. The data server of claim 38 comprising a synchronization user agent, operatively coupled to the data synchronization component and to the network protocol stack, the synchronization user agent configured to send and receive synchronization messages to and from other data stores using a synchronization protocol.

46. The data server of claim 38 comprising a synchronization user agent, operatively coupled to the data synchronization component and to the network protocol stack, the synchronization user agent configured to send and receive messages to and from a synchronization monitor, wherein the synchronization monitor tracks a synchronization progress of a synchronization operation.

47. A computer readable medium containing program instructions for synchronizing data content in a first data store client with data content in a second data store client using a presence service, the program instructions for:
determining, by the first data store client, a change in data content of the first data store client and setting a value of a status element to a first status value indicating that data content in the first data store client has changed since a prior synchronization operation, if any, occurred with the second data store client; and
sending, by the first data store client, a first message including presence information and the first value to a presence service via a publish command capable of sending the presence information including the first value compatible with a transmission format providing a status element for carrying the first value.

48. A computer readable medium containing program instructions for synchronizing data using a presence service, the program instructions for:
receiving, via a presence service, a first message including presence information from a first data store client of a group of data stores, the first message compatible with a transmission format including a status element for carrying a first status value indicating that content in the first data store client has changed since a prior synchronization operation, if any, occurred with a second data store client of the group; and
in response to receiving the first message, sending a second message that enables a synchronization operation to occur for synchronizing content of the first data store client and the second data store client based on the change in the content of the first data store client.
